(19) United States
(12) Patent Application Publication
(10) Pub. No.: US 2014/0146974 A1
(43) Pub. Date: May 29, 2014

(54) METHOD AND SYSTEM FOR TESTING A HEARING DEVICE FROM A REMOTE LOCATION

(71) Applicants: Harald Krueger, Affoltern am Albis (CH); Stefan Launer, Zurich (CH); Michael Boretzki, Ruti (CH)

(72) Inventors: Harald Krueger, Affoltern am Albis (CH); Stefan Launer, Zurich (CH); Michael Boretzki, Ruti (CH)

(73) Assignee: PHONAK AG, Stafa (CH)

(21) Appl. No.: 14/131,250

(22) PCT Filed: Jul. 13, 2011
(86) PCT No.: PCT/EP2011/061958

§ 371 Date: Jan. 7, 2014

(51) Int. Cl. H04R 25/00

(52) U.S. Cl. CPC H04R 25/30
USPC 381/60

(57) ABSTRACT

A method is proposed for testing a hearing device (1) located at a first location (L1), said hearing device (1) comprising a microphone (2) and a receiver (3) operationally connected to said microphone (2). The proposed method comprises the steps of providing a test signal to a first loudspeaker (4), providing with said first loudspeaker (4) an input audio signal to said microphone (2), sensing with a second microphone (5) an output audio signal from said receiver (3) to provide a second microphone signal, transmitting said second microphone signal from said first location (L1) to a second location (L2) distant from said first location (L1) via a communication network (6) to provide a received second microphone signal, and providing said received second microphone signal to an individual (7) located at said second location (L2). Furthermore, a system is proposed for performing such a method for remotely testing a hearing device (1).

### TECHNICAL FIELD

The present invention is related to a method for testing a hearing device as well as a system for performing such a method.

### BACKGROUND OF THE INVENTION

Hearing devices are typically small ear-level devices used to improve the hearing capability of hearing impaired people. This is achieved by picking up the surrounding sound with a microphone of a hearing device, processing the microphone signal thereby taking into account the hearing impairment of the user of the hearing device and providing the processed sound signal into an ear canal of the user via a miniature loudspeaker, commonly referred to as a receiver. Such hearing devices are exposed to considerable wear and their performance usually degrades after a prolonged period of use. In particular components such as microphone protection members, wax guards, the microphones and receivers themselves, acoustic tubing and filters, etc., which are exposed to dirt such as sweat, ear wax, talc, dust and grit may get clogged so that their performance is impaired. Moreover, mechanical stress applied to a hearing device, such as when it is dropped on the floor or through its regular daily handling, can lead to malfunctioning or reduced effectiveness of the hearing device. Therefore, hearing devices need to be tested regularly in order to ensure reliable operation. Conventionally, hearing device users will visit a hearing device professional, such as for instance a hearing device distributor or an audiologist, to get help in this respect. However, sometimes this is not possible because of the long travel time and/or distance involved in getting to a hearing device professional, the expense involved or the inability of the hearing device user to travel at all when he is somehow handicapped.

In order to allow a user to test his hearing device without the need to go to a hearing device professional various self tests and means for performing these have been proposed which the user can carry out himself. In this regard reference is made to the teachings provided in EP 1 322 138 A2, EP 1 333 701 A2, EP 1 865 746 A2, DE 103 54 897 A1, U.S. Pat. No. 6,671,643 B2, U.S. 2008/0253579 A1, and WO 2011/029959 A2. With all of these known methods and apparatuses the user is given a test result which informs him whether the hearing device is functional or needs to be attended to. However, little to no information is supplied as to the cause of impaired performance or malfunction, hence the user cannot take any action on his own to remedy the problem. Therefore, the user often has no other choice than to go to a hearing device professional for further help.

It is therefore an object of the present invention to provide a method which allows a more effective testing of a hearing device and enables an improved diagnosis of potential performance problems. It is a further object of the invention to propose a system for performing such a method for testing a hearing device.

### SUMMARY OF THE INVENTION

The present invention is directed to a method for testing a hearing device located at a first location, said hearing device comprising a microphone and a receiver operationally connected to said microphone, said method comprising the steps of:
providing a test signal to a first loudspeaker;
providing with said first loudspeaker an input audio signal to said microphone;
sensing with a second microphone an output audio signal from said receiver to provide a second microphone signal;
transmitting said second microphone signal from said first location to a second location distant from said first location via a communication network to provide a received second microphone signal; and
providing said received second microphone signal to an individual located at said second location.

In this way said individual, such as a hearing health care professional, e.g. an audiologist, or a care giver located distantly, e.g. in another room, another house or even another town, from the user of the hearing device can help determine if the hearing device is performing well or shows signs of degraded performance by listening to the output of the receiver of the hearing device in response to a test signal applied to the microphone of the hearing device. His experience will enable the individual to diagnose possible problems from his remote location and provide immediate advice as to their solution without the user having to physically visit e.g. an audiologist's office. This saves time and reduces cost and for instance allows to centralise a corresponding service provision at a single location, thus providing the potential for even greater cost savings.

Such a testing method according to the present invention has the advantage over the mentioned known self test techniques that evaluation of the response of the hearing device is left to an experienced professional. Moreover, the professional remotely testing the hearing device is able to select a test signal suitable to conduct a specific type of performance analysis. The outcome of such testing conducted with the aid of a professional is more meaningful, in cases where there is a problem with a hearing device, than the result of automatic self tests, which are possibly prone to providing “false alarms”, i.e. indications that a hearing device is faulty or exhibits degraded performance when in actuality it is perfectly in order. Incorporating the assistance of a professional, e.g. a hearing device distributor, into a hearing device testing method as proposed also strengthens the customer relationship between the testing service provider, such as the hearing device distributor, and the user of the hearing device and allows the former to initiate the sale of a new hearing device when he sees that the present one is coming close to the end of it life cycle, during which it is able to provide reliable and effective operation.

In an embodiment of the proposed method the step of providing said test signal to said first loudspeaker comprises at least one of the following steps:
sensing with a third microphone said individual's voice to provide a third microphone signal and transmitting said third microphone signal from said second location to said first location via said communication network;
generating with a test signal generator a generated test signal and optionally transmitting said generated test signal to said first location via said communication network, e.g. from said second location;
retrieving from a test signal database a stored test signal and optionally transmitting said stored test signal to said first location via said communication network, e.g. from said second location or from a third location being distant from said second location.

In this way the individual, e.g. an audiologist, can generate a desired test signal either by means of his own voice, by synthesising a test sound, e.g. an sinusoid or a chirp, or by replaying a recorded sound signal, depending on the functionality of the hearing device which is to be evaluated.

In further embodiments the proposed method further comprises the step of arranging said hearing device within a test enclosure, wherein said test enclosure comprises said first loudspeaker and said second microphone, and wherein said test enclosure is adapted to receive said hearing device such that sound emitted by said first loudspeaker is substantially coupled to said microphone and sound emitted by said receiver is substantially coupled to said second microphone when said hearing device is arranged within said test enclosure.

By placing the hearing device to be tested into a test enclosure, a defined test environment can be achieved which is free of disturbances such as unwanted interfering sound from the surroundings. Such a test enclosure as for instance a “measurement box” has a simple design and is inexpensive since no internal processing means for signal analysis is necessary. Furthermore, there is no need for special user controls or a display as necessary with the mentioned known self test equipment.

In further embodiments the proposed method further comprises substantially blocking sound propagation from said first loudspeaker to said second microphone and from said receiver to said microphone when said hearing device is arranged within said test enclosure.

In this way it is achieved that only the test signal is applied to the microphone of the hearing device and only the sound produced by the receiver of the hearing device is picked up by the second microphone, and direct sound from the first loudspeaker to the second microphone or feedback from the receiver of the hearing device to the microphone of the hearing device is avoided.

In further embodiments of the proposed method said hearing device further comprises an ear canal microphone, said ear canal microphone being said second microphone (i.e. acting as said second microphone), said method further comprising the step of applying a coupling means, such as for instance a cap or a cover, to said receiver and said ear canal microphone, wherein said coupling means is adapted to ensure effective coupling of said output audio signal from said receiver to said ear canal microphone.

In this way the test setup can be simplified by using parts of the device under test for performing testing, and furthermore, the ear canal microphone itself can be subjected to testing.

In further embodiments the proposed method further comprises the steps of:
capturing an image of said hearing device with a camera;
transmitting said image from said first location to said second location via said communication network to provide a received image; and
providing said received image to said individual.

By doing so the individual, e.g. an audiologist, is also able to visually inspect the hearing device under test, and can check the correctness of the arrangement of the hearing device for testing.

In further embodiments of the proposed method said received second microphone signal is provided to said individual by means of headphones or a stethoclip.

A stethoclip is a non-electric tube headset similar to a physician's stethoscope, for instance comprising a pair of sound tubes with inturned upper ends having ear tips for mounting the two sound tubes to the ears of a listener, the pair of sound tubes being combined at their lower ends and connected to a further sound tube. In contrast to a typical stethoscope having a chestpiece attached to the far end of the further sound tube, a receiver output port of a hearing device to be tested can be attached to the far end of the further sound tube. Similarly, a headset is disclosed in U.S. Pat. No. 2,498,960 which comprises a pair of tubular members attached to a hinge assembly within which a receiver (i.e. a loudspeaker) is arranged for providing sound into the pair of tubular members. Contrary to a stethoclip the headset according to U.S. Pat. No. 2,498,960 employs an electrical cord instead of a further sound tube, whereby the electrical cord supplies an electrical signal to the receiver located in the hinge assembly of the headset.

In a further embodiment of the proposed method where said received second microphone signal is provided to said individual by means of said stethoclip, said method further comprises the steps of:
applying said received second microphone signal to a second loudspeaker located at said second location; and
coupling said stethoclip to said second loudspeaker.

In this way the individual, e.g. an audiologist, can listen to the audio signal output by the receiver of the hearing device directly without being disturbed by any interfering sound present in his surroundings. Furthermore, by employing a stethoclip an audiologist can test the hearing device in a manner with which he is very familiar, namely as if attaching a hearing device to be tested directly to a sound tube of a stethoclip as described by Dillon in “Hearing aids” (Thieme, New York, 2001, ISBN 1-58890-052-5) on page 111. Using a stethoclip has the advantage that the audiologist does not need to learn a fundamentally new way of testing hearing devices.

In further embodiments the proposed method further comprises the step of calibrating said received second microphone signal such that a sound pressure level of a sound produced by said headphones or by said stethoclip at an ear drum of said individual is substantially equal to a sound pressure level of a sound signal provided to said ear drum of said individual when coupling said second microphone signal directly to said stethoclip. Moreover, if the step of providing said test signal to said first loudspeaker comprises sensing said individual's voice, then the proposed method additionally or alternatively comprises the step of calibrating said input audio signal such that a sound pressure level of a sound produced by said first loudspeaker is substantially equal to a sound pressure level of said individual's voice as sensed by said third microphone.

In this way the sound output by the hearing device under test is experienced, e.g. by an audiologist, in the same manner as if he had the hearing device under test at his office and were applying the sound output by the hearing device under test directly to a stethoclip. The audiologist is therefore able to perceive the sound produced by the remote device under test in exactly the same way as when directly testing the same hearing device at his office using a stethoclip as he is customarily used to doing when locally testing hearing devices. This for instance allows the audiologist to compare the remote hearing device with a local reference hearing device attached to a stethoclip.

Moreover, the present invention is directed to a system for remotely testing a hearing device, said system exhibiting the advantages of the proposed testing method.

The proposed system for testing a hearing device comprising a microphone and a receiver operationally connected to said microphone, comprises:
means for generating a test signal;
a first loudspeaker;
a second microphone;
a first transmitter;
a first communication receiver; and
means for providing a received second microphone signal to an individual;

wherein said means for generating said test signal are operationally connected to said first loudspeaker and said first loudspeaker is operationally connectable to said microphone, and wherein said second microphone is operationally connectable to said receiver and said second microphone is operationally connected to said first transmitter, and wherein said first transmitter is operationally connectable to said first communication receiver via a communication network, and wherein said first communication receiver is operationally connected to said means for providing said received second microphone signal to said individual.

In an embodiment of the proposed system said means for generating a test signal comprise:
a third microphone for sensing said individual's voice to provide a third microphone signal;
a second transmitter operationally connected to said third microphone for transmitting said third microphone signal from said second location to said first location via said communication network; and
a second communication receiver operationally connected to said first loudspeaker for receiving a transmitted third microphone signal as said test signal.

Alternatively or additionally said means for generating a test signal comprise:
a test signal generator for generating a generated test signal,

said alternative/additional means for generating a test signal optionally further comprising:
a second transmitter operationally connected to said test signal generator for transmitting said generated test signal from said second location to said first location via said communication network, or a third transmitter operationally connected to said test signal generator for transmitting said generated test signal from a third location being distant from said second location to said first location via said communication network; and
a second communication receiver operationally connected to said first loudspeaker for receiving the transmitted generated test signal.

As a further alternative or addition said means for generating a test signal comprise:
a test signal database comprising at least one stored test signal,

said further alternative/additional means for generating a test signal optionally further comprising:
a second transmitter operationally connected to said test signal database for transmitting a stored test signal from said second location to said first location via said communication network, or a third transmitter operationally connected to said test signal database for transmitting a stored test signal from a third location being distant from said second location to said first location via said communication network; and
a second communication receiver operationally connected to said first loudspeaker for receiving the transmitted stored test signal.

In further embodiments the proposed system further comprises:
first sound coupling means adapted to substantially couple said input audio signal from said first loudspeaker to said microphone; and
second sound coupling means adapted to substantially couple said output audio signal from said receiver to said second microphone.

In further embodiments the proposed system further comprises a test enclosure comprising said first loudspeaker, said second microphone, and hearing device receiving means adapted to receive said hearing device such that sound emitted by said first loudspeaker is substantially coupled to said microphone and sound emitted by said receiver is substantially coupled to said second microphone when said hearing device is arranged within said test enclosure.

In further embodiments of the proposed system said second microphone is not comprised in said system and instead said hearing device further comprises an ear canal microphone, said ear canal microphone being said second microphone (i.e. acting as said second microphone), wherein said system further comprises a coupling means adapted to be applied at said receiver and said ear canal microphone, wherein said coupling means is further adapted to ensure effective coupling of said output audio signal from said receiver to said ear canal microphone.

In further embodiments the proposed system further comprises a camera for capturing an image of said hearing device, said camera being operationally connectable to said communication network for transmitting said image from said first location to said second location, and optionally said camera being part of said test enclosure.

In further embodiments of the proposed system said means for providing said received second microphone signal to said individual comprise headphones or a stethoclip.

In further embodiments of the proposed system where said means for providing said received second microphone signal to said individual comprise said stethoclip, said system further comprises a second loudspeaker which is coupled to said stethoclip.

It is expressly pointed out that any combination of the above-mentioned embodiments is subject of further possible embodiments. Only those embodiments are excluded that would result in a contradiction.

Such methods and systems according to the invention could also be used advantageously within the context of remote fitting such as for instance proposed in DE 199 38 318 A1. During fitting the settings, e.g. signal processing parameters, of a hearing device are adjusted so as to meet the specific needs and preferences of a certain hearing device user, for instance the hearing device settings are adapted such that the hearing device compensates the individual hearing impairment of the hearing device user. The fitting procedure is typically performed at an audiologist's office, but can also be performed remotely, if for instance the hearing device user is unable or unwilling to travel to the audiologist's office. In order to test the performance of a remotely fitted hearing device, an audiologist can employ the proposed system and apply the method for testing a hearing device from a remote location as provided by the present invention. Such remote testing of a fitted hearing device allows to verify if the fitting data, i.e. the hearing device settings, were correctly transferred to and stored in the hearing device, i.e. if the hearing device was programmed as intended. This can be checked by making sure that the hearing device reacts in an expected way to certain test signals, i.e. that its behaviour is plausible in light of the performed adjustments of the settings of the hearing device. By using the system and method according to the present invention the audiologist can test the fitted hearing device remotely in much the say way as when testing it locally with a stethoclip, i.e. he is not required to learn a fundamentally new way of testing hearing devices.

### BRIEF DESCRIPTION OF THE DRAWINGS

The present invention is further described with reference to the accompanying drawing jointly illustrating various exemplary embodiments which are to be considered in connection with the following detailed description. What is shown in the only figure is the following:

FIG. 1 depicts in a schematic illustration a system according to the present invention—including various possible alternatives—suitable for performing the proposed method for remotely testing a hearing device according to the invention.

### DETAILED DESCRIPTION OF THE INVENTION

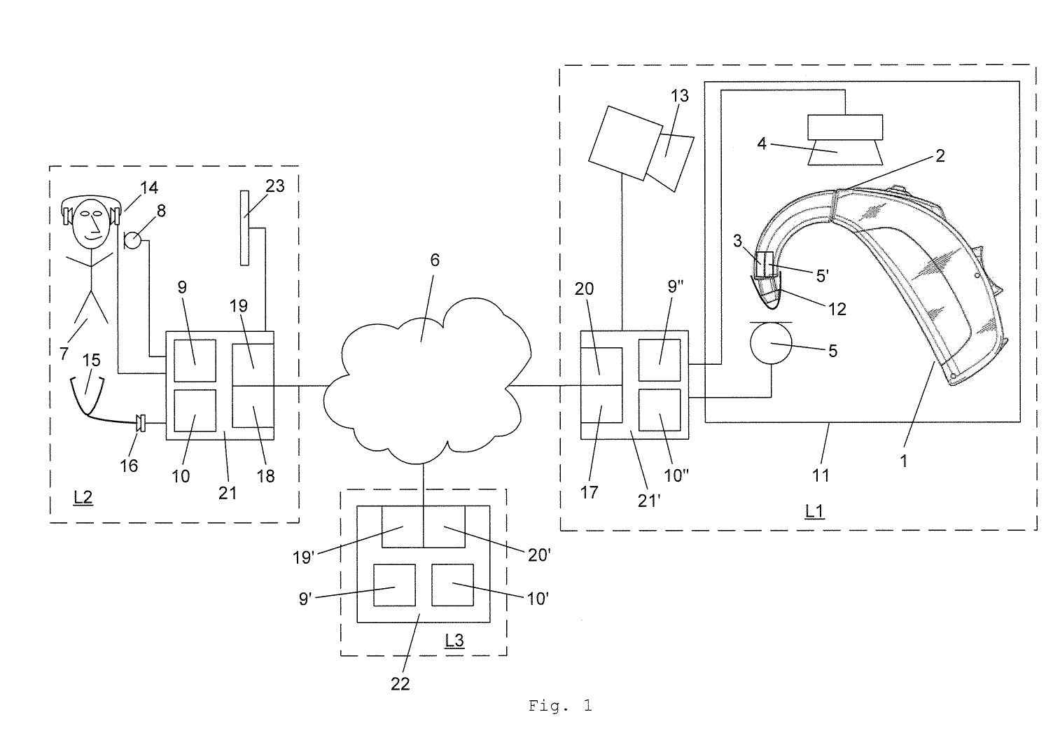

In FIG. 1 a system for remotely testing a hearing device 1 is schematically depicted. The hearing device 1 to be tested can basically be any style hearing device, e.g. a hearing device adapted to be worn behind the ear (BTE), partly or completely in the ear canal (ITE or CIC) or a hybrid type comprising both a BTE and an ITE unit (e.g. receiver in the ear, RITE or canal receiver technology, CRT). In FIG. 1 a BTE style hearing device is crudely illustrated having a microphone 2 for picking up sounds from the surroundings and a receiver 3 (i.e. a miniature loudspeaker) for generating sound to be provided into the ear canal of the user of the hearing device 1, e.g. via a sound tube and an ear mould. Additionally, such a hearing device 1 also includes a signal processing unit which is connected to the microphone 2 and to the receiver 3 for processing the microphone signal dependent on the user's needs and preferences and oftentimes also in function of the prevailing sound environment. The “enhanced”, i.e. better perceivable signal is then provided to the receiver 3.

In order to achieve a defined test environment the hearing device 1 is positioned in a test enclosure 11 or “measurement box” containing a first loudspeaker 4 and a second microphone 5. The measurement box 11 provides receiving means adapted to position the hearing device 1 such that the first loudspeaker 4 is located in close proximity to the microphone 2 of the hearing device 1 and that the second microphone 5 is located in close proximity to the receiver 3 of the hearing device 1. The measurement box 11 may for instance additionally include a first sound coupling means adapted to substantially couple an input audio signal from the first loudspeaker 4 to the microphone 2 of the hearing device 1 and a second sound coupling means adapted to substantially couple an output audio signal from the receiver 3 of the hearing device 1 to the second microphone 5. The second sound coupling means may comprise a 2-cc coupler. Optionally, the measurement box 11 may further or alternatively include a sound blocking means adapted to substantially block sound propagation from the first loudspeaker 4 to the second microphone 5 and from the receiver 3 of the hearing device 1 to the microphone 2 of the hearing device 1 when the hearing device 1 is arranged within the measurement box 11. This eliminates or strongly reduces the impact of direct sound that bypasses the hearing device 1 under test from being picked up by the second microphone 5 as well as the possibility of feedback occurring from the receiver 3 of the hearing device 1 back to the microphone 2 of the hearing device 1.

A test signal is provided to the first loudspeaker 4 which is then output by the first loudspeaker 4 as an input audio signal to the microphone 2 of the hearing device 1. This input audio signal is then picked up by the microphone 2 of the hearing device 1 and processed by the signal processing unit the output of which drives the receiver 3 of the hearing device 1 thus providing an output audio signal to the second microphone 5. The output audio signal of the hearing device 1 generated in response to the test signal provided to the first loudspeaker 4 is then sent from a first location L1, where the measurement box 11 is situated, to a distant second location L2, where an supporting individual 7, such as an audiologist 7 is situated. This is achieved be connecting the second microphone 5 with a first transmitter 17 and sending the signal from the second microphone 5 to a first communication receiver 18 situated at the second location L2 over a communication network 6 such as the Internet. The received second microphone signal is then provided to the audiologist by means of headphones 14 or a stethoclip 15. In the latter case the received second microphone signal is output by a third loudspeaker 16 which is coupled to the acoustic tubing of the stethoclip 15. The audiologist 7 can thus immediately perceive the response of the hearing device 1 to the provided test signal and diagnose possible problems based on his experience in a very similar fashion as when testing a hearing device which is directly coupled to a stethoclip 15 at his office.

The audiologist 7 can chose from multiple possibilities to provide a test signal to the hearing device 1. He can for instance speak into a third microphone 8, which could be part of a headset together with the headphones 14. Alternatively, the third microphone 8 can be a separate microphone which the audiologist 7 can move around freely, so as to be able to easily vary the position/distance and/or orientation/direction at which the third microphone 8 picks up sound at the audiologist's location. Moreover, the third microphone 8 can be built into a hearing device, e.g. a mock hearing device similar to the hearing device 1 to be tested, so that it picks up sound in much the same way as the hearing device 1 to be tested would if it were present at the audiologist's location. The audiologist's voice is then sent from his office, i.e. the second location L2, to the distant measurement box 11 at the first location L1 over the communication network 6 via a second transmitter 19 and a second communication receiver 20.

Alternatively, the audiologist 7 can generate a synthetic sound using a sound generator 9, for instance with a sound card of a personal computer (PC) 21, which is then sent from the second location L2 to the first location L1 over the communication network 6 via the second transmitter 19 and the second communication receiver 20. Alternatively, the audiologist 7 can provide commands over the communication network 6 to a remote PC 21′, e.g. situated at the first location L1, instructing its sound card to generate a specific synthetic test signal. Moreover, the sound generator 9′ can be situated at yet a third location L3, e.g. as part of a test sound server 22. The test sound server 22 receives commands and/or data from the audiologist's PC 21 via the communication network 6 with a third communication receiver 20′ and is able to send a synthesised test signal directly to the measurement box 11 at the first location L1 with the third transmitter 19′ via the communication network 6 and the second communication receiver 20. Alternatively, a synthesised test signal may also be sent to the measurement box 11 indirectly through the communication network 6 by first sending it back to the audiologist's PC 21 (via the third transmitter 19′ and the first communication receiver 18) from where it is then forwarded to the measurement box 11 (via the second transmitter 19 and the second communication receiver 20).

In a further embodiment, various recorded test signals can be stored in a test signal database 10, 10′, 10″ situated either at the first, second or third location, e.g. within the memory or storage of the audiologist's PC 21, the hearing device user's PC 21′ or the test sound server 22, from where a specific test sound as selected by the audiologist 7 is provided to the second loudspeaker 4.

In order to enable the audiologist 7 to experience the sound of the remote hearing device 1 under test when using either headphones 14 or a stethoclip 15 in the same way, e.g. in terms of loudness, as if he were locally testing it with a stethoclip 15, i.e. in a manner he is accustomed to when locally testing hearing devices, certain signals within the system should to be calibrated. For instance in the forward path from the second microphone 8 into which the audiologist 7 speaks to the hearing device 1 under test, the loudspeaker should preferably produce a sound signal having a sound pressure level which is identical to the sound pressure level present at the second microphone 8. Moreover, in the reverse path from the hearing device 1 under test to the audiologist 7 the second loudspeaker 16 should preferably produce a sound signal having a sound pressure level which is identical to the sound pressure level present at the second microphone 8.

In order to be able to visually inspect and monitor the hearing device 1 under test the proposed testing system can comprise a camera 13, such as a webcam, which may be incorporated as part of the measurement box 11. The image/video of the hearing device 1 is provided to the audiologist 7 over the communication network 6 and presented to him on a screen 23. This allows the audiologist 7 to see whether the hearing device 1 under test shows any signs of dirt such as clogged sound inlets, tubing or sound output ports, as well as if the hearing device 1 is correctly positioned for testing. Furthermore, he immediately becomes aware of the make, type and model of the hearing device 1 under test.

In the near future hearing devices will emerge that incorporate an ear canal microphone 5′. This extra microphone is intended to be able to measure the sound pressure level (SPL) generated by the receiver 3 of the hearing device 1 within the ear canal of the user, thus allowing to further improve the performance of the hearing device 1. This ear canal microphone 5′ (schematically indicated in FIG. 1 as part of a BTE unit, although in actuality it will more likely be part of an ITE unit) can also be employed to test the performance of the hearing device 1 by picking up the signal generated by the receiver 3 of the hearing device 1. Thus when testing such a hearing device 1 which incorporates an ear canal microphone 5′ there is no need for the second microphone 5 in the test system since the ear canal microphone 5′ then can act as the second microphone 5. In order to provide an effective coupling of the sound from the receiver 3 of the hearing device 1 to the ear canal microphone 5′ of the hearing device 1, a coupling means 12 such as for instance a cap or cover can be applied over/onto the joint opening of the receiver 3 and the ear canal microphone 5′ to the exterior of the hearing device 1. The signal picked up by the ear canal microphone 5′ can for example be relayed via a short-range inductive or Bluetooth link from the hearing device 1 to the transmitter 17 for subsequent further transmission over the communication network 6.

It is to be pointed out that a test setup is also envisaged that does not require a test enclosure 11 such as a measurement box, where the first loudspeaker 4 and the second microphone 5 (if at all necessary; cf. case of hearing device 1 with built-in ear canal microphone 5′) are provided as a single or separate units which are adapted to be coupled to the microphone 2 and the receiver 3 of the hearing device 1. Such a setup can be used in cases where the sound environment can be made to contain very little to no interference.

What is claimed is:

1. Method for testing a hearing device (1) located at a first location (L1), said hearing device (1) comprising a microphone (2) and a receiver (3) operationally connected to said microphone (2), said method comprising the steps of:
providing a test signal to a first loudspeaker (4);
providing with said first loudspeaker (4) an input audio signal to said microphone (2);
sensing with a second microphone (5) an output audio signal from said receiver (3) to provide a second microphone signal;
transmitting said second microphone signal from said first location (L1) to a second location (L2) distant from said first location (L1) via a communication network (6) to provide a received second microphone signal; and
providing said received second microphone signal to an individual (7) located at said second location (L2).

2. Method according to claim 1, wherein the step of providing said test signal to said first loudspeaker (4) comprises:
sensing with a third microphone (8) said individual's voice to provide a third microphone signal and transmitting said third microphone signal from said second location (L2) to said first location (L1) via said communication network (6).

3. Method according to claim 1, wherein the step of providing said test signal to said first loudspeaker (4) comprises at least one of the following steps:
generating with a test signal generator (9, 9′, 9″) a generated test signal and optionally transmitting said generated test signal to said first location (L1) via said communication network (6);
retrieving from a test signal database (10, 10′, 10″) a stored test signal and optionally transmitting said stored test signal to said first location (L1) via said communication network (6).

4. Method according to claim 1, further comprising the step of arranging said hearing device (1) within a test enclosure (11), wherein said test enclosure (11) comprises said first loudspeaker (4) and said second microphone (5), and wherein said test enclosure (11) is adapted to receive said hearing device (1) such that sound emitted by said first loudspeaker (4) is substantially coupled to said microphone (2) and sound emitted by said receiver (3) is substantially coupled to said second microphone (5) when said hearing device (1) is arranged within said test enclosure (11).

5. Method according to claim 1, wherein said hearing device (1) further comprises an ear canal microphone (5′), said ear canal microphone (5′) being said second microphone (5), said method further comprising the step of applying a coupling means (12) to said receiver (3) and said ear canal microphone (5′), wherein said coupling means (12) is adapted to ensure effective coupling of said output audio signal from said receiver (3) to said ear canal microphone (5′).

6. Method according to claim 1, further comprising the steps of:
capturing an image of said hearing device (1) with a camera (13);
transmitting said image from said first location (L1) to said second location (L2) via said communication network (6) to provide a received image; and
providing said received image to said individual (7).

7. Method according to claim 1, wherein said received second microphone signal is provided to said individual (7) by means of headphones (14).

8. Method according to claim 1, wherein said received second microphone signal is provided to said individual (7) by means of a stethoclip (15), said method further comprising the steps of:
applying said received second microphone signal to a second loudspeaker (16) located at said second location (L2); and
coupling said stethoclip (15) to said second loudspeaker (16).

9. Method according to claim 7, respectively, further comprising the step of:
calibrating said received second microphone signal such that a sound pressure level of a sound produced by said headphones (14) or by said stethoclip (15), respectively, at an ear drum of said individual (7) is substantially equal to a sound pressure level of a sound signal provided to said ear drum of said individual (7) when coupling said second microphone signal directly to said stethoclip (15);
and/or if the step of providing said test signal to said first loudspeaker (4) comprises sensing said individual's voice, said method further comprising the step of:
calibrating said input audio signal such that a sound pressure level of a sound produced by said first loudspeaker (4) is substantially equal to a sound pressure level of said individual's voice as sensed by said third microphone (8).

10. System for testing a hearing device (1), said hearing device (1) comprising a microphone (2) and a receiver (3) operationally connected to said microphone (2), said system comprising:
means (8, 9, 9′, 9″, 10, 10′, 10″) for generating a test signal;
a first loudspeaker (4);
a second microphone (5);
a first transmitter (17);
a first communication receiver (18); and
means (14, 15) for providing a received second microphone signal to an individual (7);
wherein said means (8, 9, 9′, 9″, 10, 10′, 10″) for generating said test signal are operationally connected to said first loudspeaker (4) and said first loudspeaker (4) is operationally connectable to said microphone (2), and wherein said second microphone (5) is operationally connectable to said receiver (3) and said second microphone (5) is operationally connected to said first transmitter (17), and wherein said first transmitter (17) is operationally connectable to said first communication receiver (18) via a communication network (6), and wherein said first communication receiver (18) is operationally connected to said means (14, 15) for providing said received second microphone signal to said individual (7).

11. System according to claim 10, wherein said means (8, 9, 9′, 9″, 10, 10′, 10″) for generating a test signal comprise:
a third microphone (8) for sensing said individual's voice to provide a third microphone signal;
a second transmitter (19) operationally connected to said third microphone (8) for transmitting said third microphone signal from said second location (L2) to said first location (L1) via said communication network (6); and
a second communication receiver (20) operationally connected to said first loudspeaker (4) for receiving a transmitted third microphone signal as said test signal;
and/or wherein said means for generating a test signal comprise:
a test signal generator (9″) for generating a generated test signal, said means for generating a test signal optionally further comprising:
a second transmitter (19) operationally connected to said test signal generator (9) for transmitting said generated test signal from said second location (L2) to said first location (L1) via said communication network (6), or a third transmitter (19′) operationally connected to said test signal generator (9′) for transmitting said generated test signal from a third location (L3) being distant from said second location (L2) to said first location (L1) via said communication network (6); and
a second communication receiver (20) operationally connected to said first loudspeaker (4) for receiving the transmitted generated test signal;
and/or wherein said means for generating a test signal comprise:
a test signal database (10″) comprising at least one stored test signal, said means for generating a test signal optionally further comprising:
a second transmitter (19) operationally connected to said test signal database (10) for transmitting a stored test signal from said second location (L2) to said first location (L1) via said communication network (6), or a third transmitter (19′) operationally connected to said test signal database (10′) for transmitting a stored test signal from a third location (L3) being distant from said second location (L2) to said first location (L1) via said communication network (6); and
a second communication receiver (20) operationally connected to said first loudspeaker (4) for receiving the transmitted stored test signal.

12. System according to claim 10, further comprising:
first sound coupling means adapted to substantially couple said input audio signal from said first loudspeaker (4) to said microphone (2); and
second sound coupling means adapted to substantially couple said output audio signal from said receiver (3) to said second microphone (5).

13. System according to claim 10, further comprising a test enclosure (11) comprising said first loudspeaker (4), said second microphone (5), and hearing device receiving means adapted to receive said hearing device (1) such that sound emitted by said first loudspeaker (4) is substantially coupled to said microphone (2) and sound emitted by said receiver (3) is substantially coupled to said second microphone (5) when said hearing device (1) is arranged within said test enclosure (11).

14. System according to claim 10, wherein said second microphone (5) is not comprised in said system, and wherein said hearing device (1) further comprises an ear canal microphone (5′), said ear canal microphone (5′) being said second microphone (5), and wherein said system further comprises a coupling means (12) adapted to be applied at said receiver (3) and said ear canal microphone (5′), wherein said coupling means (12) is further adapted to ensure effective coupling of said output audio signal from said receiver (3) to said ear canal microphone (5′).

15. System according to claim 10, further comprising a camera (13) for capturing an image of said hearing device (1), said camera (13) being operationally connectable to said communication network (6) for transmitting said image from said first location (L1) to said second location (L2), and optionally said camera (13) being part of said test enclosure (11).
